(19) United States
(12) Patent Application Publication
(10) Pub. No.: US 2017/0193651 A1
(43) Pub. Date: Jul. 6, 2017

(54) DRAWING DEVICE, DRAWING CONTROL METHOD THEREOF, AND COMPUTER-READABLE RECORDING MEDIUM

(71) Applicant: CASIO COMPUTER CO., LTD., Tokyo (JP)

(72) Inventor: Shuichi YAMASAKI, Tokyo (JP)

(73) Assignee: CASIO COMPUTER CO., LTD., Tokyo (JP)

(21) Appl. No.: 15/391,815

(22) Filed: Dec. 27, 2016

(30) Foreign Application Priority Data
Jan. 6, 2016 (JP) 2016-000891

(51) Int. Cl. G06T 7/00; G06T 11/20; G06T 7/73; G06K 9/52; A45D 29/22; A45D 34/04

(52) U.S. Cl. CPC G06T 7/0004; A45D 29/22; A45D 34/04; G06T 7/74; G06K 9/52; G06T 11/20; A45D 2029/005

(57) ABSTRACT

A drawing device includes a mounting portion on which an object having a nail is mounted, an image acquiring unit that acquires image data of an image of the nail captured from one direction by using an imaging unit which is located at an imaging position being separated from an apical position in a width direction of the nail along the one direction by an imaging length, and a processor which acquires a first position corresponding to a first end position of the nail in the image, the first end position being one end position in a width direction of the nail, acquires a nail height which is a height of the apical position from the first end position on the basis of the image data, and estimates a length from the first end position to the other end position in the width direction of the nail as a first nail width on the basis of the first position, the nail height and the imaging length.

### CROSS-REFERENCE TO RELATED APPLICATIONS

This application claims priority from Japanese Patent Application No. 2016-000891, filed on Jan. 6, 2016, of which the content is incorporated by reference in its entirety.

### BACKGROUND OF THE INVENTION

1. Field of the Invention

The present invention relates to a drawing device, a drawing control method of the drawing device, and a computer-readable recording medium.

2. Description of the Related Art

A drawing device is known which includes a holder for locking a digit (a finger or a toe), holds a digit of a nail on which drawing will be performed, and draws a design on the nail of the held digit. Such a drawing device is described in, for example, JP 2000-194838 A.

When the structure for holding a digit is provided as in the drawing device described in JP 2000-194838 A, a nail can be located at a position suitable for forming a nail design.

In order to form a fair design on a nail, it is necessary to correctly acquire a nail state (such as a curved state or an outline) as well as to locate the nail at an appropriate position.

However, when it is intended to accurately acquire an actual outline of a nail by finely measuring a curved shape along a width direction of a nail in a length direction of a digit, much time is required for acquiring the outline.

BRIEF SUMMARY OF THE INVENTION

The present invention offers the advantage of being able to provide a drawing device that can easily acquire an outline of a nail close to a measured shape of the nail without finely measuring a shape of the nail in a length direction of a digit, a drawing control method of the drawing device, and a computer-readable recording medium.

A drawing device of the present invention to achieve the advantage includes: a mounting portion on which an object is mounted, the object being a finger or a toe having a nail;

an image acquiring unit that acquires image data of an image, wherein the image is captured from one direction by using an imaging unit which is located at an imaging position, the imaging position being separated from an apical position of the nail of the object mounted on the mounting portion along the one direction and a length between the imaging position and the apical position beingan imaging length; and

a processor,

wherein the processor:

acquires a first position corresponding to a first end position of the nail in the image, the first end position being one end position in a width direction of the nail on the basis of the image data;

acquires a first nail height which is a height of the apical position in the one direction from one end position in the width direction of the nail on the basis of the image data; and

estimates a length from the first end position to the other end position in the width direction of the nail as a first nail width on the basis of the first position, the first nail height, and the imaging length.

In a drawing control method of a drawing device of the present invention to achieve the advantage, the drawing device includes a mounting portion on which an object is mounted, the object being a finger or a toe having a nail and an image acquiring unit that acquires image data of an image, wherein the image is captured from one direction by using an imaging unit, which is located at an imaging position, the imaging position being separated from an apical position of the nail of the object mounted on the mounting portion along the one direction and a length between the imaging position and the apical position being an imaging length;

the drawing control method comprising the steps of:

acquiring a first position corresponding to a first end position of the nail in the image, the first end position being one end position in a width direction of the nail on the basis of the image data:

acquiring a first nail height which is a height of the apical position in the one direction from one end position in the width direction of the nail on the basis of the image data; and

estimating a length from the first end position to the other end position in the width direction of the nail as a first nail width on the basis of the first position, the first nail height and the imaging length.

In a non-transitory computer-readable recording medium storing a drawing control program of a drawing device of the present invention to achieve the advantage, the drawing device includes a mounting portion on which an object is mounted, the object being a finger or a toe having a nail, an image acquiring unit that acquires image data of an image, wherein the image is captured from one direction by using a an imaging unit which is located at an imaging position, the imaging position being separated from an apical position of the nail of the object mounted on the mounting portion along the one direction and a length between the imaging position and the apical position being an imaging length,and a processor, and the drawing control program causes the processor to:

acquire a first position corresponding to a first end position of the nail in the image, the first end position being one end position in a width direction of the nail on the basis of the image data;

acquire a first nail height which is a height of the apical position in the one direction from one end position in the width direction of the nail on the basis of the image data, and

estimate a length from the first end position to the other end position in the width direction of the nail as a first nail width on the basis of the first position, the first nail height and a the imaging length.

### BRIEF DESCRIPTION OF THE SEVERAL VIEWS OF THE DRAWING

FIG. 1 is a perspective view illustrating an appearance of a drawing device according to an embodiment of the present invention;

FIG. 2 is a perspective view when a housing of the drawing device illustrated in FIG. 1 is sectioned along line A-A;

FIG. 3 is a cross-sectional view when a first digit insertion portion of the drawing device according to the embodiment of the present invention is sectioned along an inner surface of a right side wall and a left side wall is viewed;

FIG. 4 is a block diagram illustrating a principal configuration of the drawing device according to the embodiment of the present invention;

FIG. 5 is a flowchart illustrating a series of processes of the drawing device according to the embodiment of the present invention;

FIG. 6 is a diagram illustrating a location in which a nail width W is a maximum width WM in an image of the drawing device according to the embodiment of the present invention;

FIG. 7 is a diagram illustrating a method of calculating a real maximum nail width RWM of a nail;

FIG. 8 is a cross-sectional view of a nail at a position at which the nail width W is the maximum width WM in an image of a nail and which is acquired using an optical cutting method;

FIG. 9 is a diagram illustrating reference curve information;

FIG. 10 is a diagram illustrating a plurality of pieces of reference curve information which are prepared depending on curvature levels;

FIGS. 11A and 11B are diagrams illustrating a tendency of an entire curve shape of a nail, where FIG. 11A is a plan view when the nail is viewed from the top side and FIG. 11B is a cross-sectional view of the nail; and

FIG. 12 is a diagram illustrating a method of estimating a real nail width of a nail at positions P along a length direction of a digit.

### DETAILED DESCRIPTION OF THE INVENTION

A drawing device and a drawing control method of the drawing device according to an embodiment of the present invention will be described below in detail with reference to the accompanying drawings.

In the following description of the embodiment, the same elements are referenced by the same reference numerals.

In the following embodiment, it is assumed that a drawing device performs drawing on a nail of a finger as a drawing object. However, the drawing object in the present invention is not limited to the nail of a finger, but, for example, a nail of a toe may be used as the drawing object.

### (Entire Configuration of Drawing Device)

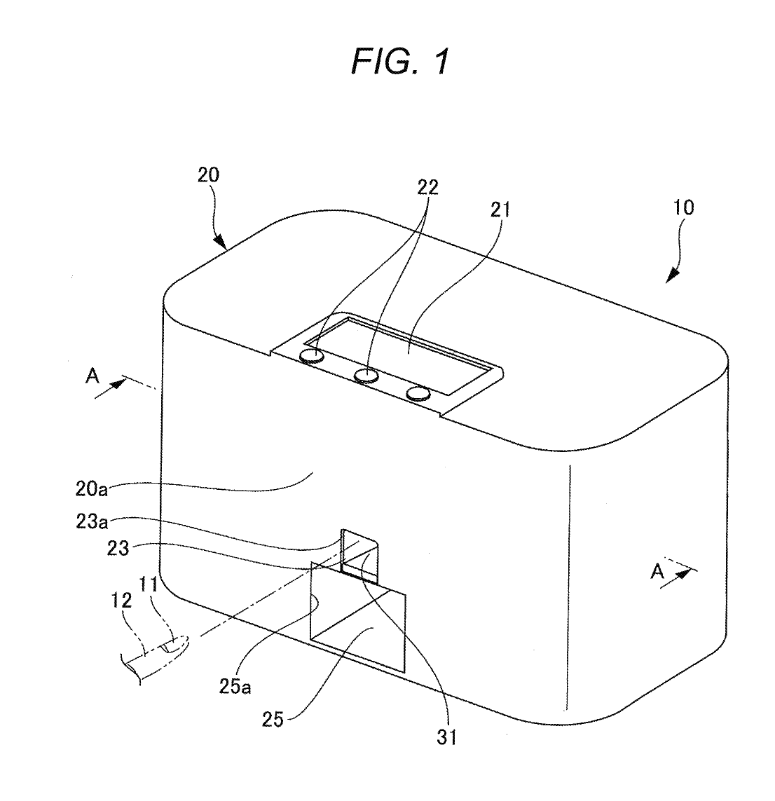

FIG. 1 is a perspective view illustrating an appearance of a drawing device 10 according to an embodiment of the present invention.

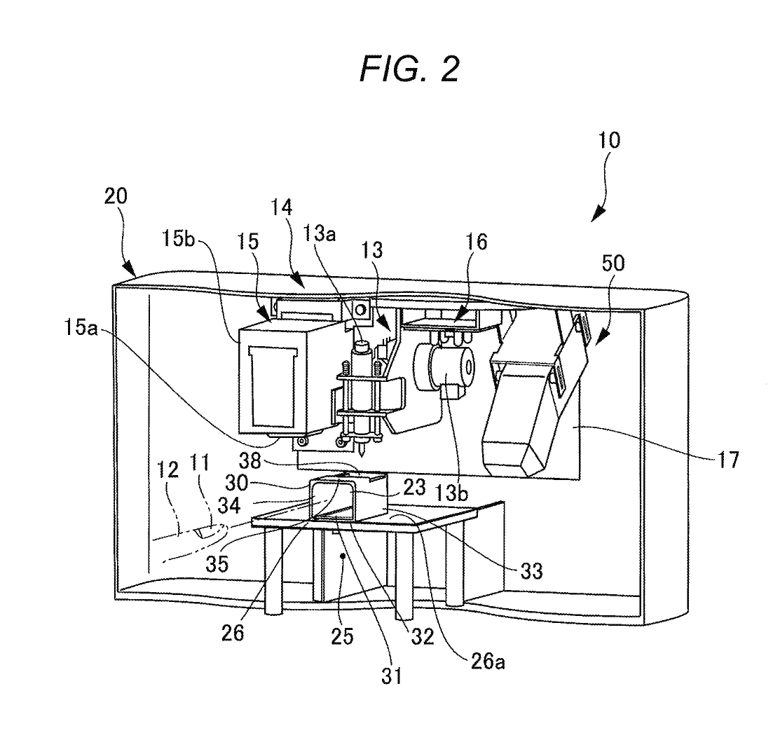

FIG. 2 is a perspective view when a housing of the drawing device illustrated in FIG. 1 is sectioned along line A-A.

As illustrated in FIG. 1, the drawing device 10 is a device that has a drawing function and that draws a nail design on a nail 11 of a human digit 12.

The drawing device 10 includes a box-like housing 20, and a display unit 21 or an operation unit 22 is disposed on a top surface (a top plate) of the housing 20. Drawing progress, a message for a user, and the like are displayed on the display unit 21. The operation unit 22 is operated by a user to carry out various input operations.

A slot 23a of a first digit insertion portion 23 is opened at the lower center of a front surface 20a of the housing 20, and a slot 25a of a second digit insertion portion 25 is opened on the lower side of the first digit insertion portion 23.

The second digit insertion portion 25 is a space into which digits other than a digit 12 as a drawing object among digits of one hand is inserted, which is formed from the front surface 20a of the housing 20 to a deep side into which the digit 12 is inserted, and which is independent of (which not communicate with) an internal space of the housing 20.

As illustrated in FIG. 2, a digit mounting portion 26 is disposed in a lower part of the housing 20.

A digit holding case 30 is disposed on a top surface (a mounting surface 26a) of the digit mounting portion 26.

An internal space of the digit holding case 30 is a space for forming the first digit insertion portion 23 (a digit insertion portion) and a digit holding portion 31 is disposed in the space as will be described later.

A fixing plate 17 is disposed to be movable in a width direction and a depth direction of the drawing device 10 in an upper part in the housing 20.

A drawing unit 14 including a pen plotter unit 13 and an ink jet unit 15, an image acquiring unit 16, and a dryer 50 are fixed to the fixing plate 17 in a state in which they are arranged in the width direction of the drawing device 10.

Accordingly, when the fixing plate 17 moves in the width direction and the depth direction of the drawing device 10, the drawing unit 14 including the pen plotter unit 13 and the ink jet unit 15, the image acquiring unit 16, and the dryer 50 move in the width direction and the depth direction of the drawing device 10 along with the fixing plate 17.

FIG. 2 illustrates an internal state of the drawing device 10 when the pen plotter unit 13 moves upward in the vertical direction relative to an opening 38 of the digit holding case 30.

The pen plotter unit 13 is a unit configured to draw, for example, a base on the surface of a nail 11, includes a pen 13a for performing the drawing on the nail 11, and can cause the pen 13a to move upward and downward in the vertical direction using a driving unit 13b such as a stepping motor.

Accordingly, the pen plotter unit 13 is movable in the width direction, the depth direction, and the vertical direction of the drawing device 10 with movement of the fixing plate 17. In a state in which the pen 13a moves downward such that the pen tip of the pen 13a comes in contact with the surface of the nail 11 after the pen 13a moves to be located just above the opening 38 of the digit holding case 30, drawing can be performed on the surface of the nail 11 using the pen tip of the pen 13a.

The ink jet unit 15 is a unit configured to print, for example, a design on the surface of a nail 11 and includes an ink jet head 15a and an ink jet cartridge 15b.

Similar to the pen plotter unit 13, in a state in which the ink jet unit 15 moves just above the opening 38 of the digit holding case 30 with movement of the fixing plate 17, a desired design can be printed on the surface of the nail 11 using the ink jet head 15a.

The image acquiring unit 16 includes, for example, a camera (an imaging unit) 16a configured to acquire an image of a nail 11 and a light source 16c, and functions as an image acquiring unit for acquiring image data including the nail 11 as a drawing object. The camera 16a may be fixed to the image acquiring unit 16 in advance or may be connected and attached to the image acquiring unit 16 only when the camera 16a is to be used.

A nail width W of a nail 11 is acquired by analyzing an image of a digit 12 including the nail 11.

The image data acquired by the image acquiring unit 16 is used to acquire information on what position of the first digit insertion portion 23 the nail 11 is located at.

The light source 16c of the image acquiring unit 16 has a function of emitting, for example, a linear beam (which is hereinafter referred to as a line beam) and irradiates the nail 11 with the line beam along the width direction of the nail 11 when a shape in a nail height direction of the nail 11 is acquired using an optical cutting method.

The camera (the imaging unit) 16a images the nail 11 in a constant imaging direction (a direction perpendicular to a recognition reference plane to be described later).

When a shape in the nail height direction of the nail 11 is acquired using the optical cutting method, the camera 16a images the nail 11 to include a linear image (a measuring image) formed on the nail 11 in a state in which the line beam is applied from the light source 16c. The image acquiring unit 16 acquires the shape in the nail height direction of the nail 11 by performing a process based on the optical cutting method on the basis of the shape of the linear image in the image data acquired as a result.

The dryer 50 is movable along with the fixing plate 17 as described above. The dryer 50 dries ink applied to the nail 11 using hot air by moving just above the opening 38 of the digit holding case 30 and blowing drying air to the surface of the nail 11.

### (Configuration of Digit Holding Case)

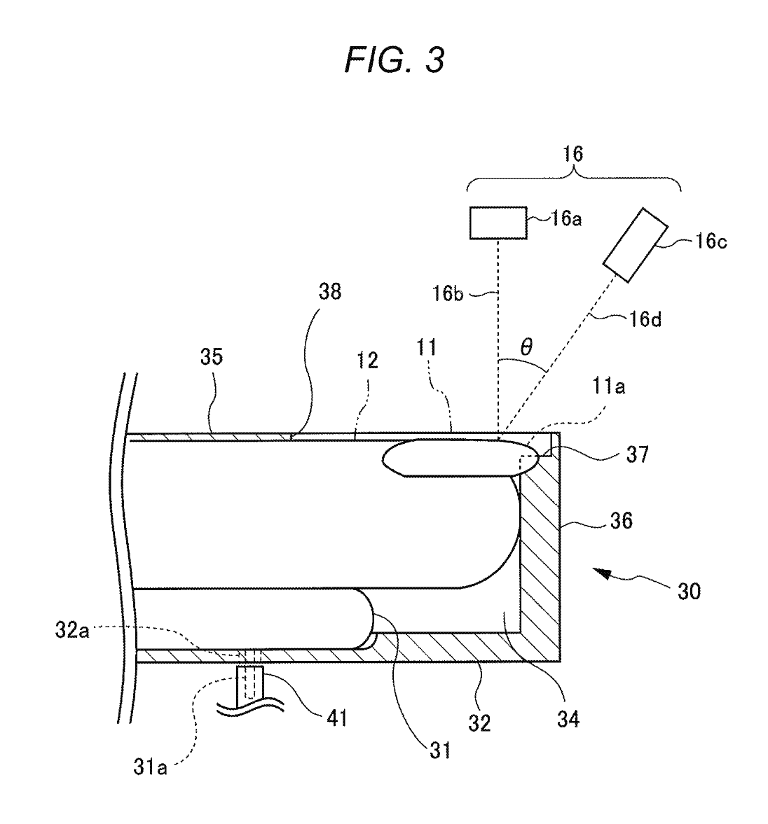

FIG. 3 is a cross-sectional view when the first digit insertion portion 23 is sectioned along an inner surface of a right side wall and a left side wall is viewed.

As illustrated in FIG. 3, the digit holding case 30 forming the first digit insertion portion 23 has a tubular shape as a whole to surround a digit 12 while exposing the tip of the digit 12.

Specifically, the digit holding case 30 includes a bottom wall 32, right and left side walls 33 and 34 extending vertically from both right and left ends of the bottom wall 32, a top wall 35 connecting the top ends of the right and left side walls 33 and 34, and a deep-side wall 36 connecting the deep-side ends in the insertion direction of the digit 12 in the right and left side walls 33 and 34.

The top end of the deep-side wall 36 is provided with a nail mounting portion 37 on which a nail tip 11a of the nail 11 is placed.

Between the top wall 35 and the deep-side wall 36, an opening 38 is formed at a position at which the nail 11 of the inserted digit 12 is exposed upward in the vertical direction.

A through-hole 32a for supplying and discharging air to and from the digit holding portion 31 is formed in the bottom wall 32.

As illustrated in FIG. 3, the camera 16a of the image acquiring unit 16 is disposed to image the nail 11 from a constant imaging direction in which an optical axis 16b thereof is substantially perpendicular to the mounting surface 26a.

The light source 16c is disposed such that an optical axis 16d thereof is inclined to the optical axis 16b of the camera 16a, and irradiates the nail 11 with a line beam from the upside. Here, an angle between the optical axis 16b of the camera 16a and the optical axis 16d of the light source 16c is defined as θ.

The camera 16a images the entire nail 11 and a part of the digit 12 to include the line (the measuring image) formed on the nail 11 by applying the line beam to the nail 11.

The image acquiring unit 16 acquires a shape in the width direction of the nail 11 of the location in which the line beam is applied to the nail 11 in the height direction of the nail 11 from the mounting surface 26a by performing a process based on the optical cutting method using the line shape formed by the line beam and the angle θ on the basis of the image data acquired by imaging using the camera 16a.

### (Configuration of Digit Holding Portion)

The digit holding portion 31 is disposed in the digit holding case 30. The digit holding portion 31 suppresses movement of the digit 12 between the top wall 35 of the digit holding case 30 and the digit holding portion 31.

Specifically, the digit holding portion 31 is formed of a bag-like member by supplying or discharging of a fluid, and is disposed to locate a flow channel 31a for supplying or discharging a fluid to and from the bag-like member in the through-hole 32a formed in the bottom wall 32.

The flow channel 31a is connected to one end 41 of a tube for supplying or discharging a fluid which is not illustrated, the digit holding portion 31 swells when the digit holding portion 31 is supplied with a fluid via the tube, and a digit 12 is fixed between the digit holding case 30 and the top wall 35 so as to locate the nail 11 at a predetermined height position as illustrated in FIG. 3.

On the other hand, when the fluid is discharged from the digit holding portion 31 via the tube, the digit holding portion 31 shrinks and the fixation of the digit 12 is released.

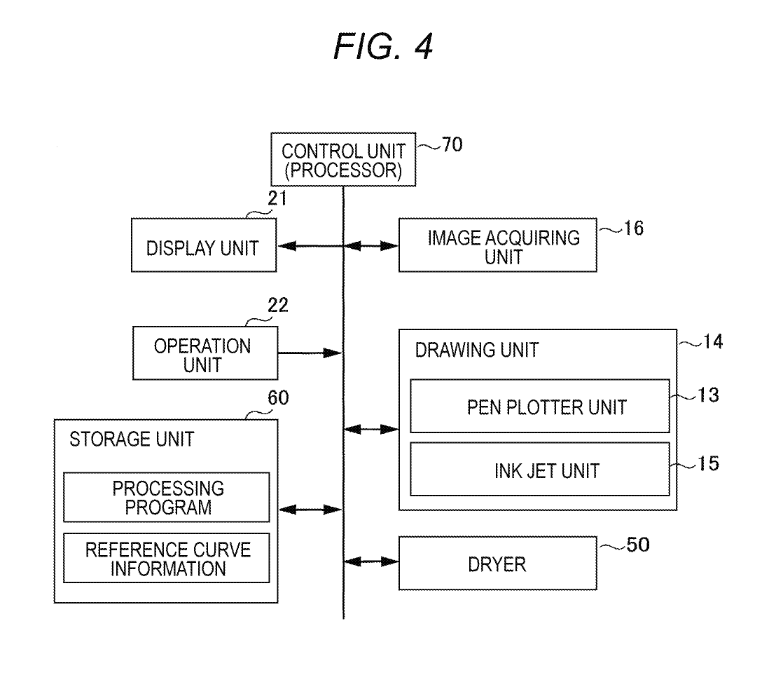

FIG. 4 is a block diagram illustrating a principal configuration of the drawing device 10.

As illustrated in FIG. 4, the drawing device 10 includes a storage unit 60 storing a processing program, reference curve information to be described later, or the like and a control unit (processor) 70 constituted by a CPU controlling various operations on the basis of the processing program, in addition to the drawing unit 14 including the pen plotter unit 13 and the ink jet unit 15, the image acquiring unit 16 including the camera 16a and the light source 16c, the display unit 21 constituted by a liquid crystal display monitor or the like, the operation unit 22, and the dryer 50, and these elements are connected to each other via a bus.

The storage unit 60 is configured to include, for example, a read only memory (ROM) and a flash memory, and includes a program area in which the processing program for realizing various functions of the drawing device 10 is stored, a data area in which data (reference curve information to be described later) used in the course of forming a nail design on a nail 11 or the like is stored, and a work area in which work data generated in the course of forming the nail design or the like is temporarily stored.

Specific operations of the drawing device 10 having the above-mentioned configuration will be described below in more detail.

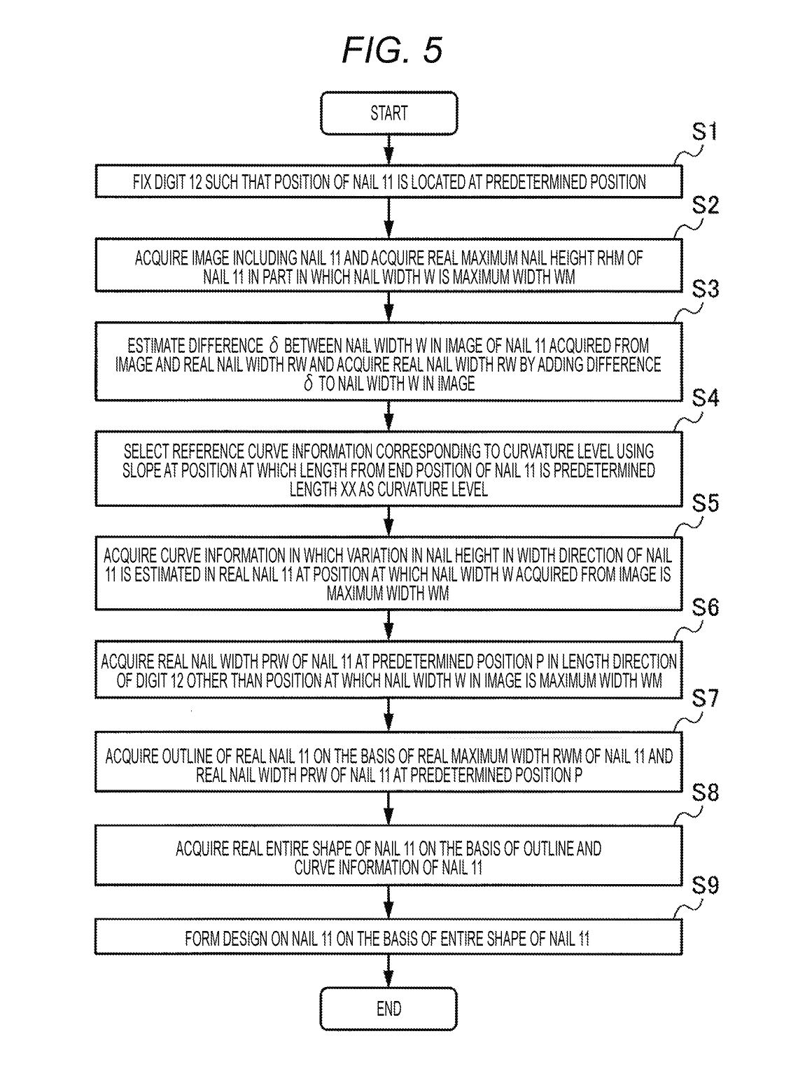

FIG. 5 is a flowchart illustrating a series of processes of the drawing device 10.

### (Start)

When a digit 12 as a drawing object is inserted into the first digit insertion portion 23 and a user operates the operation unit 22 to instruct the drawing device 10 to start its operation, control of the control unit (processor) 70 is started in accordance with the processing program and the operation of the drawing device 10 is started.

### (Step S1)

First, when the drawing device 10 starts its operation, the control unit 70 performs an operation of causing the digit holding portion 31 to swell as illustrated in FIG. 3 and fixes the digit 12 between the digit holding portion 31 and the top wall 35 of the digit holding case 30 such that a nail 11 is located at a predetermined height position.

### (Step S2)

When the fixation of the digit 12 is completed, the control unit 70 acquires a position PS of one end in the width direction of the nail 11 at which the nail width W is a maximum width WM in the image of the nail 11 from the image data acquired by the image acquiring unit 16 in accordance with an image analysis program.

The positions of the camera 16a and the light source 16c are adjusted to locate the camera 16a at a position (an imaging position) just above a line drawn in the width direction of the nail 11 from the position PS on the nail 11 at which the nail width W is the maximum width WM and at which the center position of the image acquiring unit 16 is just above an apical position in the height direction in a cross-sectional shape taken along the width direction of the nail 11.

In a state in which the position PS on the nail 11 at which the nail width W is the maximum width WM or the vicinity thereof is irradiated with a line beam from the light source 16c in the width direction of the nail 11, the image acquiring unit 16 is made to function as an image acquiring unit such that the image acquiring unit 16 acquires image data of the digit 12 including the nail 11.

When the nail width W in the image is required in the processing course as described above, the control unit 70 functions as a nail width acquiring unit in accordance with the image analysis program.

The nail width W in the image is a value which is obtained by calculating the nail width on the basis of a length (an imaging length) CH from the image acquiring unit 16 to the recognition reference plane, a viewing angle of a lens (not illustrated) of the camera 16a of the image acquiring unit 16, a relative dimension of the nail width W to the entire image, and the like and converting the calculated nail width into an actual dimension on the recognition reference plane.

As will be described later, the nail width W in the image acquired in this way is different from the actual width of the nail 11.

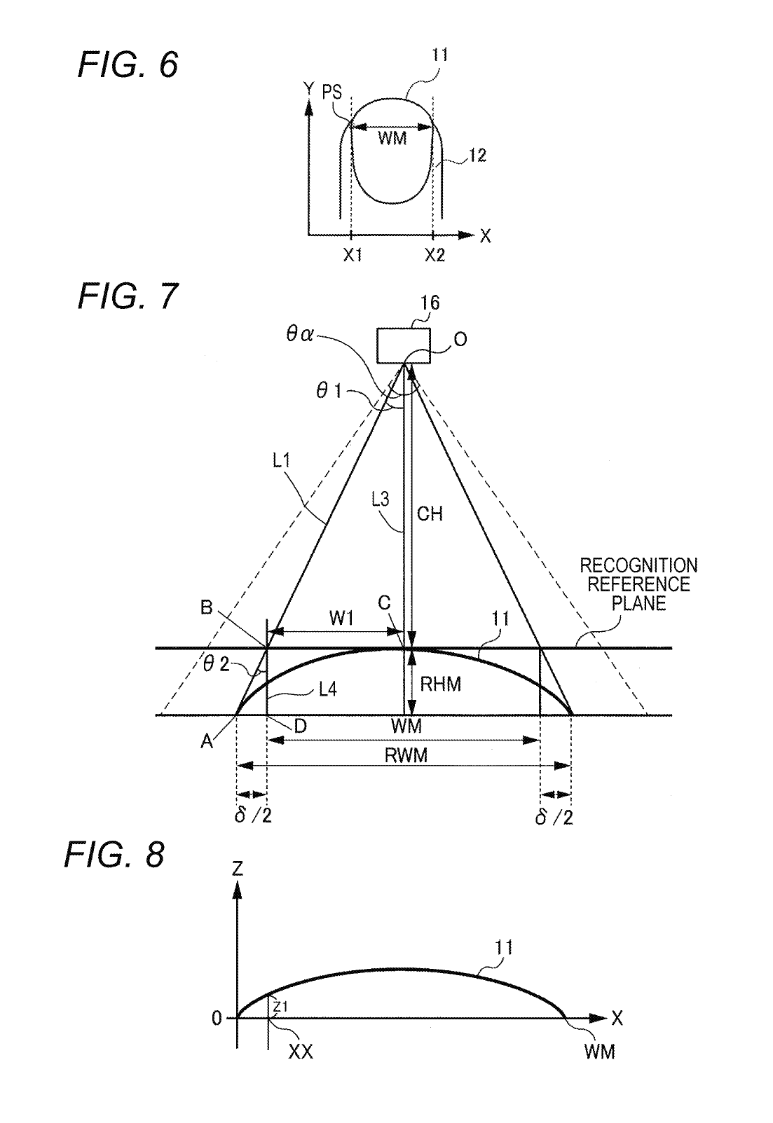

Specific description will be made below with reference to FIG. 6 illustrating a location in the image in which the nail width W is the maximum width WM.

When an XY coordinate system with the width direction of the nail 11 as an X axis is applied to the image, the nail width W in the image of the nail 11 is defined by a difference between a position of one end of the nail 11 and a position of the other end in a direction parallel to the X axis.

A location of the nail width W in the image connecting a position PS (see X1) of the end of the nail 11 located on the leftmost in the image and the position (see X2) of the end of the nail 11 located on the rightmost is defined as the location in the image in which the nail width W is the maximum width WM.

Image data of the digit 12 including the nail 11 in a state in which a position on the nail 11 corresponding to the line of the maximum width WM or the vicinity thereof is irradiated with a line beam from the light source 16c is acquired by the image acquiring unit 16.

The control unit 70 functions as a nail height acquiring unit that acquiring the height of the nail 11 to acquire a real maximum nail height (a first nail height) RHM from the end position in the width direction of a position on the nail 11 corresponding to the location in the image in which the nail width W is the maximum width WM or the vicinity thereof.

### (Step S3)

Here, the positions of the ends in the width direction of the nail 11 in the image are located more inside the nail 11 than the real end positions of the nail.

This is because the end portions in the width direction of the nail 11 are curved and a subject located at a position forming a predetermined angle about the optical axis 16b of the camera 16a of the image acquiring unit 16 is located at the same position in the acquired image even when the length from the camera 16a varies.

Therefore, in Step S3, the control unit 70 functions as a nail width estimating unit that estimates a difference δ between the nail width W in the image of the nail 11 acquired from the image data and the real nail width RW and acquires the real nail width RW by adding the difference δ to the nail width W in the image, and performs a process of calculating the real maximum nail width (the first nail width) RWM of the nail 11 at the position on the nail 11 corresponding to the location in the image in which the nail width W is the maximum width WM or the vicinity thereof.

The process of calculating the real maximum nail width RWM of the nail 11 will be specifically described below with reference to FIG. 7.

FIG. 7 is a diagram illustrating a method of calculating the real maximum nail width RWM of a nail 11.

The nail 11 illustrated in FIG. 7 is illustrated by a cross-section taken along the width direction of the nail 11 at the position on the nail 11 corresponding to the location in the image of the nail 11 in which the nail width W is the maximum width WM (see FIG. 6).

In FIG. 7, a point O denotes the center position of the camera (the imaging unit) 16a of the image acquiring unit 16.

In FIG. 7, the recognition reference plane is a virtual plane functioning as a reference of image data to be acquired and is a plane whose plane direction is perpendicular to the imaging direction of the camera 16a and which is tangent to the apical position (a point C) in the height direction in a cross-sectional shape taken along the width direction of the nail 11.

An angle θα denotes a viewing angle of a lens (not illustrated) of the camera 16a of the image acquiring unit 16.

The nail 11 illustrated in FIG. 7 is acquired on the basis of the maximum width WM of the nail width W in the image and the position of an end in the width direction of the nail 11 in the image is located at a point B (a first position). The position of the point B corresponds to the position PS in FIG. 6.

However, as described above, the point B which is the end position of the nail 11 in the image is located inside the position of the real end of the nail 11, and the real end position in the width direction of the nail 11 is present at the point A. That is, the point B is a position at which a straight line OA (a virtual straight line L1) drawn from the point O in the camera 16a of the image acquiring unit 16 to the point A as the real end position in the width direction of the nail 11 crosses the recognition reference plane.

The position of the real end in the width direction of the nail 11 is located at the point A when a triangle BAD is considered by extending the straight line OB, that is, when a triangle in which a side BD of the triangle BAD is the same as the real maximum nail height RHM of the nail 11 calculated in Step S2.

Here, a straight line OC (a virtual straight line L3) and a straight line BD (a virtual straight line L4) are drawn perpendicular to the recognition reference plane and parallel to each other. Accordingly, an angle θ1 and an angle θ2 corresponding to a corresponding angle thereof are the same and the triangle OBC and the triangle BAD forms a similar figure.

Accordingly, length of straight line BC: length of straight line AD=length of straight line OC: length of straight line BD is established.

Accordingly, length of straight line AD=length of straight line BD×[length of straight line BC/length of straight line OC] is established.

The length of the straight line OC is the length (the imaging length) CH from the camera 16a of the image acquiring unit 16 as an image acquiring unit to the recognition reference plane and is a value set in advance on the basis of the configuration of the drawing device 10.

The length of the straight line BC is a half value W1 of the maximum width WM of the nail width W in the image of the nail 11 acquired from the image data. The length of the straight line BD is the height of the point C from the point A of the nail 11 acquired in Step S2, is a length in the imaging direction of the camera 16a between the point A and the point C, and is the same as the real maximum nail height RHM.

In addition, the length of the straight line AD is equal to half the difference θ between the maximum width WM of the nail width W in the image of the nail 11 acquired from the image data and the real maximum nail width RWM at the position on the nail 11 corresponding to the location in the image in which the nail width is the maximum width WM.

Accordingly, when a half value of the maximum width WM of the nail width W in the image of the nail 11 acquired from the image data is defined as a width W1, the difference θ between the maximum width WM of the nail width W in the image of the nail 11 acquired from the image data and the real maximum nail width RWM at the position on the nail 11 corresponding to the location in the image in which the nail width is the maximum width WM can be calculated by δ=(real maximum nail height RHM×[width W1/length CH])×2. The values of the right side in the expression for calculating the difference δ are known and it is thus possible to calculate the value of δ.

In the calculation expression, units of the values to be substituted into the calculation expression are not described, but the units of the values in the calculation can be converted. For example, all the units of the values to be substituted into the calculation expression are unified as mm or pm to perform the calculation.

That is, in Step S3, the control unit 70 functioning as the nail width estimating unit performs a process of calculating (estimating) the real maximum nail width RWM of the nail 11 by estimating the difference δ between the maximum width WM of the nail width W in the image of the nail 11 acquired from the image data and the real maximum nail width RWM at the position on the nail 11 corresponding to the location in the image in which the nail width is the maximum width WM on the basis of the half value W1 of the maximum width WM of the nail width W in the image acquired from the image data, the length CH from the camera 16a of the image acquiring unit 16 as the image acquiring unit to the recognition reference plane, and the real maximum nail height RHM of the nail 11 and adding the difference δ to the maximum width WM of the nail 11 acquired from the image data.

### (Step S4)

Then, the control unit 70 calculates a curvature level a value of a slope obtained by dividing the real nail height Z1 at a position at which a length from an end position of the nail 11 is a predetermined length XX in the location in the image of the nail 11 in which the nail width W is the maximum width WM and which is acquired using the optical cutting method in Step S2 by the length XX, and selects the reference curve information corresponding to the calculated curvature level. At this time, the control unit 70 functions as a reference curve information selecting unit.

The process of Step S4 will be specifically described below with reference to FIG. 8.

FIG. 8 is a cross-sectional view illustrating the same cross-section of the nail 11 as illustrated in FIG. 7 and is a cross-sectional view of the nail 11 at the position in the image of the nail 11 at which the nail width W is the maximum width WM and which is acquired using the optical cutting method.

In FIG. 8, with respect to one end position of the nail 11, the width direction of the nail is represented by the X axis and the nail height direction is represented by the Z axis.

The optical cutting method is a measuring technique of acquiring the value of the real nail height at each position in the width direction of the nail 11. Accordingly, the real nail height Z1 at a position (for example, a position corresponding to 1/10 of the maximum width WM of the nail 11 acquired from the image data) at which the length of the location in the image of the nail 11 in which the nail width W is the maximum width WM from the end position of the nail 11 is a predetermined length XX can be acquired from the measurement result thereof.

The value of the slope obtained by dividing the real nail height Z1 by the predetermined length XX is defined as the curvature level.

From the measured results of curve shapes of many nails 11, it can be seen that the calculated value of the slope is suitable for classifying a difference in the entire curve shape of the nail 11. Accordingly, the value of the slope is defined as the curvature level.

The value of the slope at a position corresponding to, for example, ⅛ of the maximum width WM of the nail width W in the image of the nail 11 acquired from the image data of the nail 11 may be defined as the curvature level. The predetermined length XX can be set to a length within a range in which the curve shape of an end position of the nail 11 can be easily estimated from the end of the nail 11.

On the other hand, as illustrated in FIG. 4, the reference curve information is stored in the storage unit 60 of the drawing device 10. The reference curve information will be described below.

Plural pieces of reference curve information are stored in the storage unit 60 so as to select the reference curve information depending on the curvature level as described above.

In order to easily understand the reference curve information, a piece of reference curve information will be first described below and then how plural pieces of reference curve information are different from each other will be described.

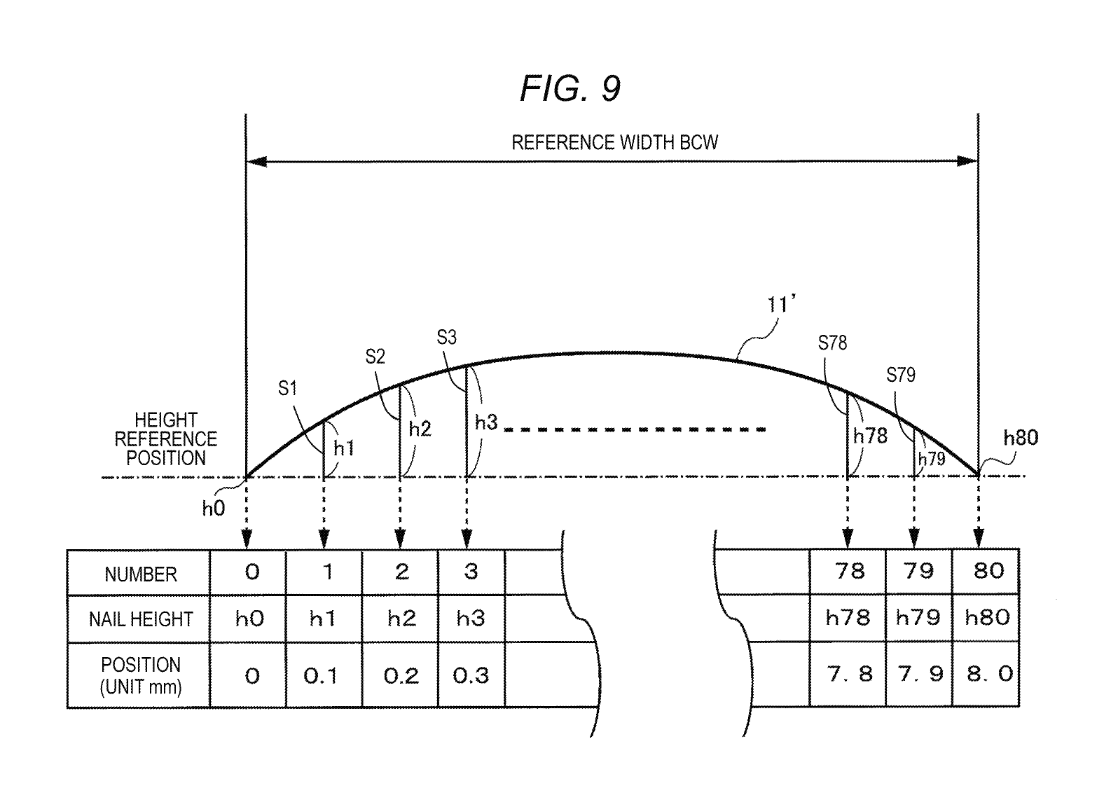

FIG. 9 is a diagram illustrating the reference curve information.

FIG. 9 is a diagram corresponding to a cross-section of a nail. The nail illustrated in FIG. 9 is a reference nail 11′ which is prepared on the basis of data of plural nails.

In order to express the reference nail 11′, as illustrated in FIG. 9, height values at positions in the width direction of the reference nail 11′ (the right-left direction in the drawing) with respect to a height reference position (see a one-dot chained line) at which the height is 0 and at which both end positions of the reference nail 11′ are straightly connected are recorded in the reference curve information.

Specifically, in the reference curve information, a reference width BCW which is the width of the reference nail 11′ from one end position in the right-left direction (the left end position in the drawing) of the reference nail 11′ to the other end position in the right-left direction (the right end position in the drawing) is divided into plural uniform intervals by dividing boundary lines S1 to S79, and the one end position and the other end position of the reference nail 11′ and boundary positions corresponding to the dividing boundary lines S1 to S79 are numbered.

In this embodiment, the width of the reference nail 11′ is set to 8 mm, the boundary positions are arranged at the uniform intervals with a pitch of 0.1 mm (see the positions), the numbers increase sequentially toward the other end position (the right end position in the drawing) with the number of the one end position (the left end in the drawing) as 0, and the number of the other end position is 80.

That is, the one end position of the reference nail 11′, the plural boundary positions corresponding to the dividing boundary lines S1 to S79 at the uniform intervals, and the other end position are numbered from the one end position to the other end position of the reference nail 11′.

The numbers indicating the positions are given and nail heights h0, hl, h2, h3, . . . , h78, h79, h80 are given to the numbers as data indicating the curve shape in the width direction of the reference nail 11′.

Information in which a variation of the nail height in the nail width direction in the reference nail 11′ is recorded is the reference curve information.

The reference curve information is corrected and is applied as a curve shape of the nail 11 close to a measured shape to the location corresponding to the maximum nail width RWM in the nail 11, and the curve shape of the nail 11 close to a measured shape is acquired (estimated) at a position P which is different in the length direction of the digit 12 from the position on the nail 11 at which the nail width W is the maximum width WM in the image of the nail 11 using the corrected reference curve information.

Accordingly, it is possible to acquire the curve shape of the nail 11 close to a measured shape without finely measuring the width of the nail 11 and the curve shape in the nail width direction along the length direction of the digit 12.

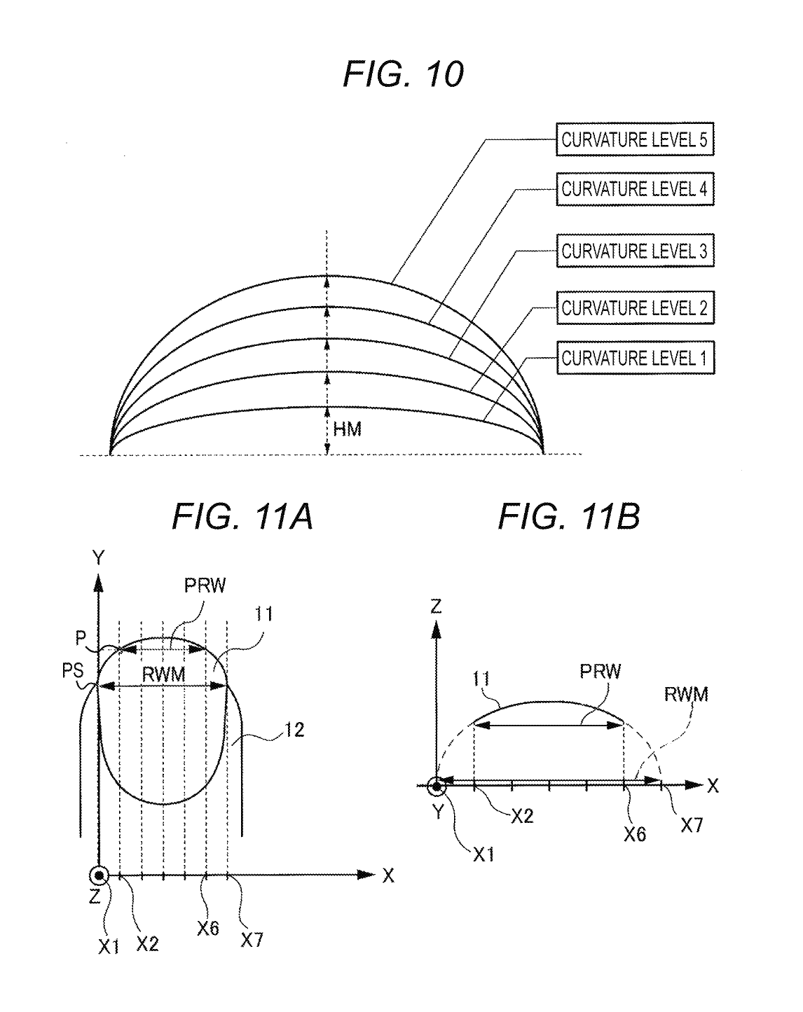

It is difficult to cope with the shapes of various nails 11 using only one piece of reference curve information. Accordingly, in this embodiment, as illustrated in FIG. 10, the curvature levels are divided into curvature level 1 to curvature level 5 having different degrees of curving and five pieces of reference curve information which are the same as described above with reference to FIG. 9 are stored in advance in the storage unit 60 to correspond to the curvature levels. In FIG. 10, the table illustrated in FIG. 9 is not illustrated.

Accordingly, among curvature level 1 to curvature level 5, the reference curve information closest to the real curve shape of the nail 11 is selected depending on the above-mentioned curvature level.

The method of acquiring the real curve shape of the nail 11 using the reference curve information will be described later.

When the reference curve information is selected in Step S4 as described above, the process of Step S5 is performed.

Here, in order to easily understand the process details of Step S5 and the steps subsequent thereto, how the selected reference curve information is utilized to acquire the entire curve shape of the nail 11 close to a really measured shape of the nail 11 will be described below before Step S5 will be described.

FIGS. 11A and 11B are diagrams illustrating a tendency of the entire curve shape of a nail 11.

FIG. 11A is a plan view when the nail 11 is viewed from the top side, and FIG. 11B is a cross-sectional view of the nail 11.

In FIGS. 11A and 11B, a direction parallel to the length direction of a digit 12 is defined as the Y axis, the width direction of the nail 11 is defined as the X axis, and the nail height direction is defined as the Z axis.

In FIG. 11A, a position PS (the first position) at which the real width of the nail 11 is the maximum nail width RWM (the maximum width WM in the image) and a position P at which the real width of the nail 11 is a nail width PRW different from the maximum nail width RWM and which is different from the position on the nail 11 at which the real width of the nail 11 is the maximum nail width RWM are illustrated.

In FIG. 11B, a curve indicating a variation of a nail height in the width direction of the nail 11 at the position PS corresponding to the maximum nail width RWM (the maximum width WM) in the nail 11 is denoted by a dotted line, and a curve indicating a variation of the nail height in the width direction of the nail 11 at the position P is denoted by a solid line.

As illustrated in FIG. 11A, one end position (the left end position in the drawing) in the width direction of the nail 11 in the location corresponding to the maximum nail width RWM in the nail 11 (the location corresponding to the maximum width WM in the image) is located at the origin X1 on the X axis, and the other end position (the right end position in the drawing) is located at a position X7 on the X axis.

The gaps in the X-axis direction of plural dotted lines denoting the positions X1 to X7 are uniform.

At the position P, the one end position (the left end position in the drawing) of the nail 11 at the position at which the real width of the nail 11 is the nail width PRW is located at the position X2 on the X axis, and the other end position (the right end position in the drawing) is located at the position X6 on the X axis.

That is, the positions of the ends (both end positions) of the nail 11 at the position P are located closer by one scale to the center of the nail 11 than the positions (X1 and X7) of the ends (both end positions) of the nail at the position corresponding to the maximum nail width RWM (the location corresponding to the maximum width WM in the image) in the X-axis direction.

In FIG. 11B, the positions (X2 and X6) of the ends (both end positions) of the nail 11 at the position P are located closer by one scale to the center of the nail 11 than the positions (X1 and X7) of the ends (both end positions) of the nail at the position corresponding to the maximum nail width RWM (the location corresponding to the maximum width WM in the image) in the X-axis direction.

In this way, the positions of the ends of the nail 11 at the position P are different from the positions of the ends of the nail 11 at the position corresponding to the maximum nail width RWM of the nail 11, but as can be seen from FIG. 11B, the curve shape in the width direction (the X-axis direction) of the nail 11 at the position P is close to the curve shape in the width direction (the X-axis direction) of the position corresponding to the maximum nail width RWM of the nail 11 (the location corresponding to the maximum width WM in the image).

Accordingly, when the curve shape of the nail 11 (the variation of the nail height in the width direction of the nail 11) at the position corresponding to the maximum nail width RWM of the nail 11 (the location corresponding to the maximum width WM in the image) and the real outline of the nail 11 can be acquired, it is possible to estimate the real entire shape of the nail 11 on the basis of the acquired data.

That is, at a position which is deviated in the length direction of the digit 12 from the position corresponding to the maximum nail width RWM of the nail 11 (the location corresponding to the maximum width WM in the image), the length in the X-axis direction of the outline of the nail 11 is smaller than the maximum nail width RWM as can be seen from FIGS. 11A and 11B. Accordingly, as the curve shape of the nail 11 at a position which is deviated in the length direction of the digit 12 from the position corresponding to the maximum nail width RWM, a shape within a range in which the length in the X-axis direction of the outline of the nail 11 is smaller than the maximum nail width RWM among the curve shapes of the nail 11 at the position corresponding to the maximum nail width RWM can be applied.

When the real nail width PRW of the nail 11 at a position P in the length direction of the digit 12 can be estimated, it is possible to estimate the real outline of the nail 11 when viewed from the upside by applying the estimated nail width PRW to the nail width PW in the image of the nail 11 at the position P.

On the other hand, in Step S3, the estimated value of the real maximum nail width RWM of the nail 11 at the position at which the nail width W of the nail 11 in the image is the maximum width WM is already acquired.

Accordingly, in principal processes of Step S5 and the steps subsequent thereto, the curve shape at the position and the real nail width PRW of the nail 11 at the position P in the length direction of the digit 12 are estimated from the reference curve information on the assumption that the real width of the nail 11 at the location in which the nail width W in the image of the nail 11 is the maximum width WM is the maximum nail width RWM.

Step S5 and the steps subsequent thereto of performing the above-mentioned processes will be described below on the basis of the above-mentioned description with reference to the flowchart illustrated in FIG. 5.

### (Step S5)

In Step S5, the control unit 70 functions as a curve information acquiring unit that acquires curve information including the estimated variation of the real nail height in the width direction of the nail 11 at the position at which the nail width W is the maximum width WM in the image acquired from the image data, and acquires the curve shape (the curve information) at the position corresponding to the maximum nail width RWM of the nail 11 or the vicinity thereof.

At this time, since the real maximum nail width RWM of the nail 11 at the position at which the nail width W is the maximum width WM in the image acquired from the image data is normally different from the reference width BCW which is the width of the reference nail 11′ in the reference curve information, a process of matching the widths is first performed.

Specifically, the control unit 70 functioning as the curve information acquiring unit divides the real maximum nail width RWM of the nail 11 in the same number as in the reference curve information, and gives the same numbers as in the reference curve information to the divided parts from one end position of the nail 11 to the other end position of the nail 11.

That is, when the width direction of the reference nail 11′ is divided into 80 parts at uniform intervals in the reference curve information, the real maximum nail width RWM of the nail 11 is divided into 80 parts at the uniform intervals using dividing boundary lines T1 to T79 so as to acquire the same state. With the number of position of one end of the nail 11 as 0, the positions of the dividing boundary lines T1 to T79 are sequentially numbered toward the other end position, and the number of the position of the other end of the nail 11 is numbered 80.

The numbers function as the numbers of pieces of curve information.

At this time, in the same way as illustrated in FIG. 9, position information from the one end position of the nail 11 is also added to the numbers.

By applying the value of the nail height in the reference curve information with the same number (see h0 to h80 in FIG. 9) as the nail height of the curve information with the same number as in the reference curve information, the variation of the nail height in the width direction is introduced into the curve information.

At this time, the values of the nail heights in the reference curve information (see h0 to h80 in FIG. 9) are not merely applied without any change, but the corrected reference curve information in which the nail heights are corrected using a coefficient F is used.

The coefficient F corresponds to a difference between a corrected maximum height HM when the nail width in the reference curve information is corrected to match the real width of the nail 11 and the real maximum nail height RHM of the nail 11.

That is, the width of the reference nail 11′ in the reference curve information is set to 8 mm, and the curves in the reference curve information are corrected to be enlarged or reduced in the width direction and the height direction by a ratio of the real maximum nail width RWM to the nail width (RWM/8 mm) in the reference curve information such that the width matches the real maximum nail width RWM of the nail 11 when the maximum height is HM.

Then, a ratio (RHM/HMA) of the real maximum nail height RHM of the nail 11 to the corrected maximum height HMA in the corrected reference curve information is calculated. The calculation result is the coefficient F.

When the corrected reference curve information is acquired in this way, the next step is performed.

### (Step S6)

Then, the control unit 70 functions as a nail width estimating unit and acquires the real nail width PRW of the nail 11 at the position P which is different from the position at which the nail width W in the image is the maximum width WM in the length direction of the digit 12.

At this time, the control unit 70 extends the nail width W at the position at which the nail width W of the nail 11 in the image is the maximum width WM to the maximum nail width RWM which is the real width of the nail, and applies the corrected reference curve information acquired in Step S5 as the information on the nail height in the width direction of the nail 11 regarding the extended width of the nail 11.

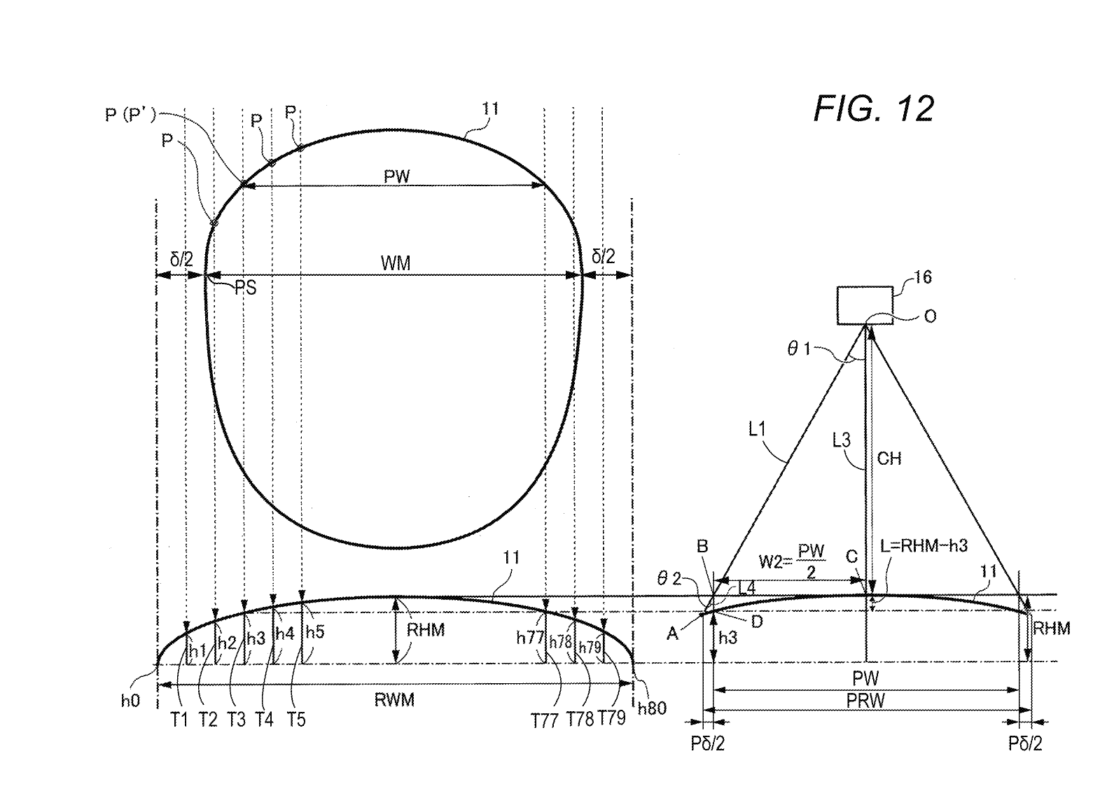

Specifically, description will be made below with reference to FIG. 12 which is a diagram illustrating the method of estimating the real nail width of the nail 11 at the position P in the length direction of the digit 12.

As illustrated in FIG. 12, at the position PS at which the nail width W of the nail 11 in the image is the maximum width WM, positions which are obtained by extending the positions of one end and the other end of the nail 11 to the outside by the difference δ/2 of which the calculation method is described above in Step S3 are the positions of the ends of the real maximum nail width RWM of the nail 11.

Therefore, when the positions of the real ends of the nail 11 are determined in this way and the curve information thereof is assigned, the variation of the height in the width direction of the nail 11 illustrated below the nail 11 is correlated with the curve information.

Here, the position P is a position crossed by the outline of the nail 11 in the image when the nail width W at the position PS at which the nail width W of the nail 11 is the maximum width WM is extended to the real maximum nail width RWM of the nail and the dividing boundary lines T1 to T79 for dividing the extended width of the nail into the same number of parts as in the reference curve information are extended in the length direction of the digit 12 in the drawing.

For example, when the position P is a position P′ and the nail width W in the image at the position P′ is a nail width PW, the real cross-section of the nail 11 at the position can be estimated to be the same as illustrated in the right part of FIG. 12.

The right drawing of FIG. 12 is the same as FIG. 7, where the nail 11 is drawn with the nail width PW in the image and thus the nail width PW is smaller than the real width of the nail 11.

That is, as described above with reference to FIG. 7, in the image, the point B is one end position in the width direction of the nail 11, but the real end position in the width direction of the nail 11 is located farther from the center than the point B and the real end position of the nail 11 is located at the point A on an extension line of the straight line OB (the virtual straight line L1). The position of the point A is located at a position with which a triangle with L as the length of the straight line BD (the virtual straight line L4) can be drawn in the triangle BAD with the same angle θ2 as the angle θ1.

The length L is a value obtained by subtracting the height of the position of the point A from the real maximum nail height RHM of the nail 11. Here, the height of the point D is h3 in the curve information corresponding to the position The position of the point A is slightly lower than the height of the point D. However, the difference between the height of the point D and the height of the point A is generally very small. Accordingly, the height of the position of the point A can be considered to be h3. Accordingly, the length L can be calculated as a value obtained by subtracting h3 from the real maximum nail height RHM of the nail 11.

The length of the straight line BC is calculated to be a half value W2 (=PW/2) of the nail width PW at the position P′ in the image, and the length of the straight line OC (the virtual straight line L3) is the length CH.

Accordingly, the length of the straight line AD can be calculated by performing the same calculation as described with reference to FIG. 7, and two times of the length of the straight line AD corresponds to a difference Pδ between the nail width PW of the nail 11 in the image at the position P′ and the real nail width PRW of the nail 11 in the location of the nail width PW.

Specifically, since the difference Pδ can be calculated by Pδ=(L×[W2/length CH])×2, the real nail width PRW of the nail 11 at the position P′ is calculated by adding the difference PS to the nail width PW of the nail 11 in the image at the position P′.

This calculation can be applied when the position P is a position P other than P′.

Accordingly, it is possible to estimate the real nail width PRW of the nail 11 at positions P in the length direction of the digit 12.

### (Step S7)

Since the real maximum nail width RWM of the nail 11 and the real nail width PRW of the nail 11 at the position P are acquired through the above-mentioned steps, the real outline of the nail 11 is acquired on the basis of the acquired widths in Step S7.

Specifically, the control unit 70 functions as an outline acquiring unit and acquires the outline by replacing the nail width W at each position of the nail 11 in the image with the real nail width (the maximum nail width RWM and the nail width PRW) on the basis of the nail widths.

### (Step S8)

Since the real outline of the nail 11 could be acquired through the above-mentioned step, the control unit 70 functions as a nail shape acquiring unit and acquires a real entire shape (an outline) of the nail on the basis of the outline and the curve information of the nail as described above in Step S8.

### (Step S9)

In Step S9 which is the final step, the drawing unit 14 forms a design on the nail on the basis of the entire shape of the nail acquired by the nail shape acquiring unit, and the series of processes ends.

This series of processes is a process of forming a nail design on a single nail 11. Accordingly, when a nail design is formed on a nail 11 of another digit 12, the series of processes from start to end is repeatedly performed.

In the above-mentioned series of processes, the real shape of the nail 11 is measured only when the optical cutting method is performed in Step S2. Accordingly, it is not necessary to finely measure the curve shape in the width direction of the nail along the length direction of the digit in practice. As a result, it is possible to greatly shorten the process time in comparison with a case in which the curve shape in the width direction of the nail is measured in practice.

While an exemplary embodiment of the present invention has been described above in detail, the present invention is not limited to the embodiment.

In the above-mentioned embodiment, in Step S2, the curve shape in the width direction of the nail 11 is measured using the optical cutting method. However, the method of measuring the curve shape in the width direction of the nail 11 is not limited to the method. Another method capable of measuring the curve shape in the width direction of the nail 11 may be employed.

The process flow from Step S1 to Step S9 in the above-mentioned embodiment may include a step which causes no problem even when the order is changed, and the step causing no problem even when the order of the step is changed may be changed in the order.

The present invention is not limited to a specific embodiment, but can be modified or changed in various forms without departing from the gist of the present invention, which can be apparent to those skilled in the art from the appended claims.

What is claimed is:

1. A drawing device comprising:
a mounting portion on which an object is mounted, the object being a finger or a toe having a nail;
an image acquiring unit that acquires image data of an image, wherein the image is captured from one direction by using an imaging unit which is located at an imaging position, the imaging position being separated from an apical position of the nail of the object mounted on the mounting portion along the one direction and a length between the imaging position and the apical position being an imaging length; and
a processor,
wherein the processor:
acquires a first position corresponding to a first end position of the nail in the image, the first end position being one end position in a width direction of the nail on the basis of the image data;
acquires a first nail height which is a height of the apical position in the one direction from one end position in the width direction of the nail on the basis of the image data; and
estimates a length from the first end position to the other end position in the width direction of the nail as a first nail width on the basis of the first position, the first nail height and the imaging length.

2. The drawing device according to claim 1, wherein:
the processor:
acquires a first cross position where a virtual straight line drawn from the imaging unit to the first end position in the width direction of the nail crosses a recognition reference plane which is tangent to the apical position of the nail and whose plane direction is perpendicular to the one direction as the position of the first end position of the nail in the image as the first position, and
estimates the first nail width on the basis of the imaging length, the first cross position, and the first nail height.

3. The drawing device according to claim 2, further comprising a plurality of pieces of reference curve information having different curvatures; wherein
the processor
acquires a curve shape in the one direction of the nail along the width direction from the first end position on the basis of the image data,
selects a specific piece of reference curve information corresponding to the acquired curve shape of the nail from the plurality of pieces of reference curve information,
acquires a second cross position where a virtual straight line drawn from the image acquiring unit to a second end position other than the first end position which is one end position in the width direction of the nail crosses the recognition reference plane on the basis of the image data,
estimates a maximum value of a length in the one direction from the second end position at positions in the width direction from the second end position of the nail as a second nail height on the basis of the specific piece of reference curve information and the second cross position, and
estimates a length between the second end position of the nail and the other end position in the width direction as a second nail width on the basis of the imaging length, the second cross position, and the second nail height.

4. The drawing device according to claim 3, further comprising a drawing unit that performs drawing on the nail; wherein
the processor
acquires an entire shape of the nail on the basis of the specific piece of reference curve information, the estimated first nail width, and the estimated second nail width, and
controls the drawing unit so as to perform drawing on the nail on the basis of the acquired entire shape of the nail.

5. The drawing device according to claim 3, wherein;
the processor
corrects the specific piece of reference curve information such that the maximum value of the height in the specific piece of reference curve information matches the first nail height, and
estimates the second nail height on the basis of the corrected specific piece of reference curve information.

6. The drawing device according to claim 1, wherein the image includes a measuring image which is formed in a linear shape in the width direction on the nail, wherein
the processor acquires the first nail height which is the height of the nail on the basis of the shape of the measuring image.

7. The drawing device according to claim 1, wherein:
the processor sets the position of the first end position to a position at which the length in the width direction is a maximum in the length direction of the nail in the image.

8. A drawing control method of a drawing device, in which the drawing device includes a mounting portion on which an object is mounted, the object being a finger or a toe having a nail and an image acquiring unit that acquires image data of an image, wherein the image is captured from one direction by using an imaging unit which is located at an imaging position, the imaging position being separated from an apical position of the nail of the object mounted on the mounting portion along the one direction and a length between the imaging position and the apical position being an imaging length;
the drawing control method comprising the steps of:
acquiring a first position corresponding to a first end position of the nail in the image, the first end position being one end position in a width direction of the nail on the basis of the image data:
acquiring a first nail height which is a height of the apical position in the one direction from one end position in the width direction of the nail on the basis of the image data; and
estimating a length from the first end position to the other end position in the width direction of the nail as a first nail width on the basis of the first position, the first nail height and the imaging length.

9. The drawing control method of the drawing device according to claim 8, wherein the step of estimating the first nail width includes the steps of:
acquiring a first cross position where a virtual straight line drawn from the imaging unit to the first end position of the nail crosses a recognition reference plane which is tangent to the apical position of the nail and whose plane direction is perpendicular to the one direction as the position of the first end position of the nail in the image as the first position, and
estimating the first nail width on the basis of the imaging length, the first cross position, and the first nail height.

10. The drawing control method of the drawing device according to claim 9, wherein the drawing device further includes a plurality of pieces of reference curve information having different curvatures, and
the drawing control method further comprises the steps of:
acquiring a curve shape in the one direction of the nail along the width direction from the first end position on the basis of the image data,
selecting a specific piece of reference curve information corresponding to the acquired curve shape of the nail from the plurality of pieces of reference curve information,
acquiring a second cross position where a virtual straight line drawn from the image acquiring unit to a second end position other than the first end position which is one end position in the width direction of the nail crosses the recognition reference plane on the basis of the image data,
estimating a maximum value of a length in the one direction from the second end position at positions in the width direction from the second end position of the nail as a second nail height on the basis of the specific piece of reference curve information and the second cross position, and
estimating a length between the second end position of the nail and the other end position in the width direction as a second nail width on the basis of the imaging length, the second cross position, and the second nail height.

11. The drawing control method of the drawing device according to claim 10, wherein the drawing device further includes a drawing unit that performs drawing on the drawing object, and
the drawing control method further comprises the steps of acquiring an entire shape of the nail on the basis of the specific piece of reference curve information, the estimated first nail width, and the estimated second nail width, and
controlling the drawing unit so as to perform drawing on the nail on the basis of the acquired entire shape of the nail.

12. The drawing control method of the drawing device according to claim 10, wherein the step of estimating the second nail width of the nail includes the steps of:
correcting the specific piece of reference curve information such that the maximum value of the height in the specific piece of reference curve information matches the first nail height, and
estimating the second nail height on the basis of the corrected specific piece of reference curve information.

13. A non-transitory computer-readable recording medium storing a drawing control program of a drawing device, the drawing device including a mounting portion on which an object is mounted, the object being a finger or a toe having a nail, an image acquiring unit that acquires image data of an image, wherein the image is captured from one direction by using an imaging unit which is located at an imaging position, the imaging position being separated from an apical position of the nail of the object mounted on the mounting portion along the one direction and a length between the imaging position and the apical position being an imaging length, and a processor, the drawing control program causing the processor to:
acquire a first position corresponding to a first end position of the nail in the image, the first end position being one end position in a width direction of the nail on the basis of the image data;
acquire a first nail height which is a height of the apical position in the one direction from one end position in the width direction of the nail on the basis of the image data, and
estimate a length from the first end position to the other end position in the width direction of the nail as a first nail width on the basis of the first position, the first nail height and a the imaging length.

14. The non-transitory computer-readable recording medium storing the drawing control program of the drawing device according to claim 13, wherein the drawing control program causes the processor to
acquire a first cross position where a virtual straight line drawn from the imaging unit to the first end position of the nail crosses a recognition reference plane which is tangent to the apical position of the nail and whose plane direction is perpendicular to the one direction as the position of the first end position of the nail in the image as the first position, and
estimate the first nail width on the basis of the imaging length, the first cross position, and the first nail height.

15. The non-transitory computer-readable recording medium storing the drawing control program of the drawing device according to claim 14, wherein the drawing device includes a plurality of pieces of reference curve information having different curvatures, and
the drawing control program causes the processor to
acquire a curve shape in the one direction of the nail along the width direction from the first end position on the basis of the image data,
select a specific piece of reference curve information corresponding to the acquired curve shape of the nail from the plurality of pieces of reference curve information,
acquire a second cross position where a virtual straight line drawn from the image acquiring unit to a second end position other than the first end position which is one end position in the width direction of the nail crosses the recognition reference plane on the basis of the image data,
estimate a maximum value of a length in the one direction from the second end position at positions in the width direction from the second end position of the nail as a second nail height on the basis of the specific piece of reference curve information and the second cross position, and
estimate a length between the second end position of the nail and the other end position in the width direction as a second nail width on the basis of the imaging length, the second cross position, and the second nail height.
